(19) United States
(12) Patent Application Publication
(10) Pub. No.: US 2005/0069121 A1
(43) Pub. Date: Mar. 31, 2005

(54) Routing telephone calls

(76) Inventors: Mohammad A. Faruque, Chandler, AZ (US); Venkata Kiran Vedantam, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/675,416

(22) Filed: Sep. 29, 2003

(51) Int. Cl. H04M 3/42; H04M 7/00

(52) U.S. Cl. 379/225; 379/211.02; 379/221.01

(57) ABSTRACT

An incoming telephone call is received at a private branch exchange. The telephone call is directed to a telephone extension of the private branch exchange. A call routing preference associated with the extension is determined and the telephone call is routed based on the call routing preference. If the call routing preference is set to a first preference, telephone call is routed to a telephone associated with the extension. If the call routing preference is set to a second preference, the telephone call is routed to a computing device associated with the extension.

### TECHNICAL FIELD

This disclosure relates generally to Internet Protocol (IP) telephony, and more particularly to routing telephone calls to a computing device using IP telephony.

### BACKGROUND

Missed telephone calls are a common problem. In particular, missed telephone calls can hinder productivity in an office environment. Often, by the time a missed telephone call is returned, a decision has already been made and a user's input is too late to be considered. When a called party (callee) is away from their desk or is otherwise not available, a caller typically has several options. The caller may leave a message, which will require a return telephone call once the called party receives the message. The caller may follow up with another call later, but there is no assurance that the callee will be available at the later time. For example, the caller may attempt to call an alternate telephone number, such as a cellular telephone or a pager. However, calls involving a cellular telephone typically are not considered to be as secure as conventional telephone calls over a private branch exchange, and for that reason, discussing sensitive matters over cellular phones is often discouraged. A pager may notify the called party that there was an attempt to contact them, but it does not connect the caller with the callee. In some cases, a callee can set up automatic call forwarding, which forwards incoming telephone calls to another telephone number. However, this only defers the problem if the called party is also not available at the forwarded telephone number. None of these alternatives adequately address the need for prompt communication between a caller and a callee.

### BRIEF DESCRIPTION OF THE DRAWINGS

FIG. 1 illustrates an embodiment of a call routing system 100.

FIG. 2 illustrates an embodiment of a network suitable for practicing the present invention.

FIG. 3 illustrates an embodiment of a computer system suitable for use in practicing the present invention.

FIG. 4 illustrates a flow chart of an embodiment of a call routing method.

FIG. 5 illustrates a flow chart of an embodiment of a call routing preference method.

### DETAILED DESCRIPTION

In the following detailed description of embodiments of the invention, reference is made to the accompanying drawings in which like references indicate similar elements, and in which, by way of illustration, specific embodiments in which the invention may be practiced are shown. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

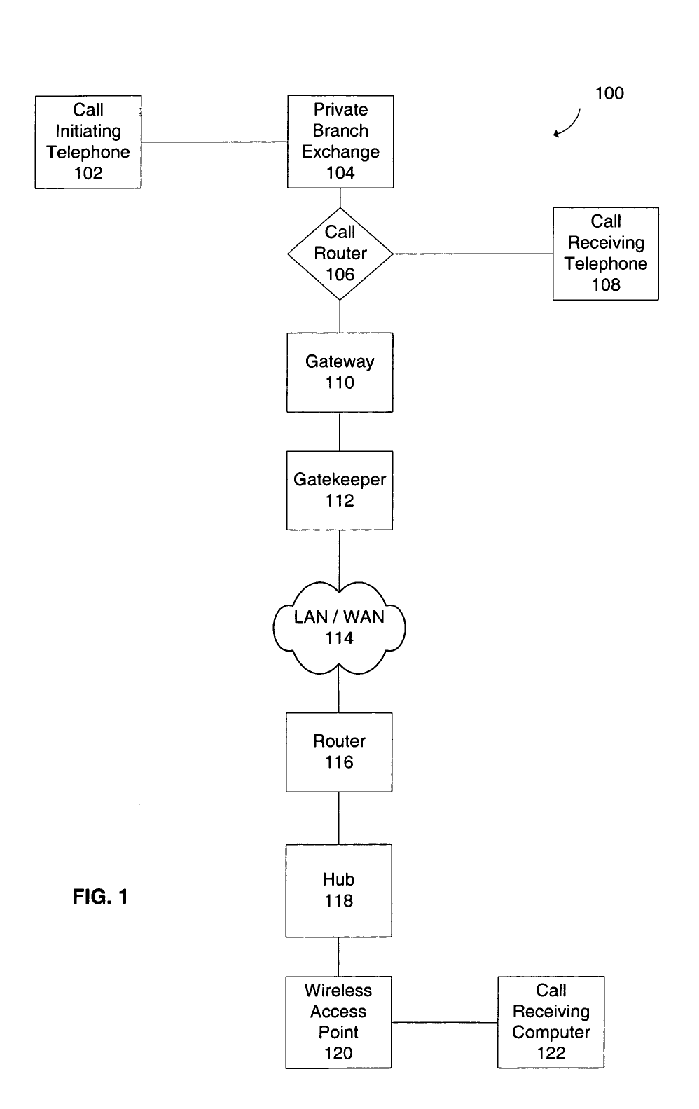

A system level overview of the operation of an embodiment of the invention is described with reference to FIG. 1. An embodiment of a call routing system 100 is described. Routing system 100 includes call initiating telephone 102, private branch exchange 104, Call Router 106, call receiving telephone 108, Gateway 110, Gatekeeper 112, LAN/WAN (Local Area Network/Wide Area Network) 114, Router 116, Hub 118, Wireless Access Point 120 and call receiving computer 122.

A call initiating telephone 102 may be any telephone or device used to initiate a telephone call. In one embodiment, telephone 102 initiates calls over the Public Switched Telephone Network (PSTN). Telephone 102 includes such devices as standard telephones connected to the PSTN, public telephones, and cellular phones. Private Branch Exchange (PBX) 104 is a telephone switching system within an enterprise that interconnects telephone extensions to each other as well as to the outside telephone network (PSTN). An organization which uses computers is commonly referred to as an enterprise. An enterprise typically includes several different types of networks and computer systems.

PBX 104 receives an incoming telephone call from telephone 102. In one embodiment, the incoming telephone call is directed to a telephone extension of the PBX 104. For example, in one embodiment, the incoming telephone call is directed to a telephone number or extension connected to the PBX 104. In one embodiment, PBX 104 is located at an office of the callee. In one embodiment, telephone 102 is connected to an outside telephone line and is external from the enterprise. In one embodiment, telephone 102 is an internal telephone at the enterprise which is connected to the PBX 104.

PBX 104 may include functions such as call routing for outside calls, call forwarding, conference calling and call accounting. In one embodiment, PBX 104 uses all-digital methods for switching. In one embodiment, PBX 104 uses analog methods for switching. In one embodiment, PBX 104 supports both analog and digital telephones and telephone lines. In one embodiment, PBX 104 is a Private Automatic Branch Exchange (PABX). PBX 104 directs the incoming telephone call to a Call Router 106.

Call Router 106 handles the routing of calls received by the PBX 104. In one embodiment, Call Router 106 includes a server running software to handle routing of calls. For example, in one embodiment, calls received by the PBX 104 are routed through the Call Router 106. In one embodiment, Call Router 106 handles call routing for a plurality of extensions of the enterprise. In another embodiment, Call Router 106 handles the routing for a single extension. For example, in one embodiment, an enterprise has an individual Call Router 106 associated with each call receiving telephone 108 or telephone extension. In one embodiment, the Call Router 106 acts as a switch to route calls to either a call receiving telephone 108 or a call receiving computer 122.

Call Router 106 is configurable to determine the routing of calls. For example, in one embodiment, the Call Router 106 is connected to a network and is accessible via a telephone line, a local intranet or the Internet. In one embodiment, a user may access the Call Router 106 via a web browser interface. The user may utilize the browser interface to select and set call routing preferences using a menu. In one embodiment, a user accesses a call routing preference menu through a telephone interface, in which a user uses a telephone menu to configure the call router. For example, in one embodiment, the user indicates a call routing preference by pressing buttons on a telephone in response to audible menu prompts.

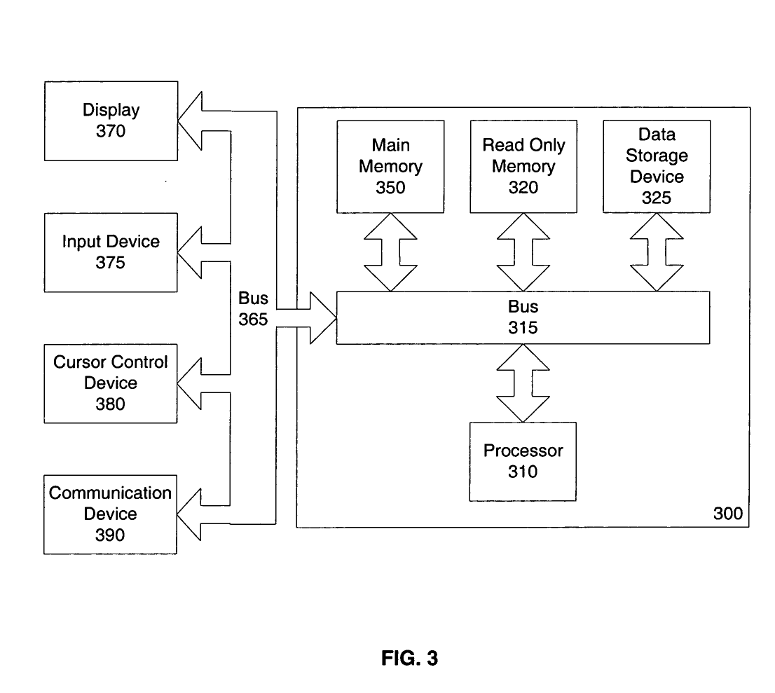

In one embodiment, a user has the option of receiving calls at the call receiving telephone 108, or the user may select an option to have calls routed to a call receiving computer 122. It will be appreciated that other options for routing calls and means for selecting routing options are contemplated. For example, in one embodiment, Call Router 106 may be configured to route calls to either a call receiving telephone 108 or a call receiving computer 122 using a toggle switch or a manual dial selector. A call receiving computer 122 is a computing device such as a laptop computer or a desktop computer. In one embodiment, call receiving computer is a computing device such as that described below with respect to FIG. 3.

In one embodiment, the Call Router 106 automatically sets the preference to route calls to the call receiving computer 122. For example, in one embodiment, the call receiving computer 122 is a laptop computer. When the laptop computer is detached from a docking station, the Call Router 106 automatically sets the call routing preference to route calls to the call receiving computer 122. In another embodiment, when the call receiving computer 122 is docked to the docking station, the Call Router 106 automatically sets the call routing preference to route calls to the call receiving telephone 108.

The Call Router 106 routes calls based on the call routing preference. Where the Call Router 106 is configured to route calls to a call receiving telephone 108, calls received by PBX 104 are routed through the Call Router 106 to the call receiving telephone 108. In one embodiment, call receiving telephone 108 is a standard telephone connected to PBX 104 via the Call Router 106. In one embodiment, the call is routed to the call receiving telephone 108 without converting the protocol of the voice signal. For example, in one embodiment, the call is routed to the call receiving telephone 108 in an analog format.

Where the Call Router 106 is configured to route calls to a call receiving computer 122, the Call Router 106 routes calls to Gateway 110. Gateway 110 receives calls from the Call Router 106 which are routed to the call receiving computer 122. Gateway 110 encodes and repackages a circuit-switched call into Internet Protocol (IP) packets. Delivering voice information using IP is generally referred to as Voice over Internet Protocol (VoIP). VoIP is a term used in IP telephony for a set of facilities for managing the delivery of voice information using the Internet Protocol. In general, VoIP describes sending voice information in digital form in discrete packets, rather than in the traditional circuit-committed protocols of the Public Switched Telephone Network (PSTN).

In one embodiment, Gateway 10 is an IP/PSTN Gateway, meaning that Gateway 10 converts protocols between a PSTN network and an IP network to connect the traditional voice world, on one side, to packet-based devices on the other. In one embodiment, Gateway 10 converts voice signals into streams of digital packets for transmission over computer networks. This process is known as packetization. Packetization may be accomplished through hardware or software means. Voice signals, which are typically analog signals of varying amplitude and frequency over time, are converted into raw data bits of 0's and 1's. These raw data bits are then framed and “packetized” or encapsulated into network transferable units, so that the data signal can travel through networks using the Internet Protocol (IP). In one embodiment, voice packets follow the TCP/IP OSI (Transmission Control Protocol/Internet Protocol Open Systems Interface) model as shown below:
Transport Layer: RTP (Real Time Transport)/UDP (User Datagram Protocol)
Network Layer: IP (packet segmentation)
Data Layer: Raw data is framed
Physical Layer: Analog signals are converted into raw data

In one embodiment, Gateway 110 interfaces between a PSTN network and a network complying with the ITU-T H.323 standard, International Telecommunication Union Telecommunication Standardization Sector (ITU-T) H.323 standard, Version 5, published July 2003. The H.323 standard is used for the transmission of real-time audio, video, and data communications over packet-based networks. The H.323 standard specifies the components, protocols, and procedures providing multimedia communication over packet-based networks. Packet-based networks include IP-based (including the Internet) or Internet packet exchange (IPX)-based local area networks (LANs), enterprise networks (ENs) or intranets, metropolitan-area networks (MANs), and wide-area networks (WANs). The H.323 standard can be applied in a variety of mechanisms: audio only (IP telephony); audio and video (videotelephony); audio and data; and audio, video and data. The H.323 standard can also be applied to multipoint-multimedia communications. In one embodiment, Gateway 110 allows non-H.323 terminals to communicate with H.323 terminals.

In one embodiment, Gateway 110 employs a first protocol for transport of the voice packets and a second protocol for signaling. For example, in one embodiment, transport is provided by UDP over IP for voice packets and either UDP or TCP over IP for signals. Signaling commands to establish and terminate the call, as well as to provide special features such as call forwarding, call waiting and conference calling, may be provided for by a signaling protocol such as H.323. It will be appreciated that other protocols may be used. For example, other suitable signaling protocols that may be used include SIP (Session Initiation Protocol) and MGCP/MEGACO (Media Gateway Control Protocol/Media Gateway Controller).

The packetized voice data is forwarded from Gateway 110 to a Gatekeeper 112. In one embodiment, Gatekeeper 112 provides address translation and control access to the LAN/WAN 114 for the Gateway 110. In one embodiment, Gatekeeper 112 is an H.323 entity on the enterprise intranet. The Gatekeeper 112 may provide other services, such as bandwidth management and locating remote network gateways. Gatekeeper 112 directs the packetized voice data to a destination network address, such as an Internet Protocol (IP) address. In one embodiment, Gatekeeper 112 accesses a table which maps call receiving telephone extensions or aliases with usernames. A username is the login or name users enter to identify themselves when logging onto a computer or network system. Typically both a username and a password are required. For example, usernames known as USER IDs are used with some Windows® operating systems, such as Windows®NT. The Gatekeeper 112 uses the username to determine a current network address associated with the username. The table storing telephone extensions and usernames may be stored in an enterprise database or at the Gatekeeper 112. Additionally, the Gatekeeper 112 may store a table associating usernames with current network addresses. For example, in a DHCP (Dynamic Host Configuration Protocol) system, when a user logs onto an enterprise intranet using their username, an IP address is assigned to the user's workstation for that login session. The Gatekeeper 112 may then resolve the IP address assigned to the username, thereby identifying where to forward packetized voice data for a particular user.

The voice packets are transmitted from Gatekeeper 112 over a local area network (LAN) or a wide area network (WAN) 114 to a Router 116. In one embodiment, LAN 114 includes an enterprise intranet or network. In one embodiment, WAN 114 includes the Internet. In one embodiment, the voice data packets are transmitted over the Internet to Router 116. In another embodiment, where the destination for the voice data packets is on a local network, the voice data packets are transmitted over a LAN 114. In one embodiment, for transmission of voice data packets to remote locations, such as those accessible through a WAN 114 or the Internet, encrypted protocols for the voice data packets are employed to provide increased security.

The voice data packets are received at Router 116. Router 116 is an entry/exit point (i.e. a gateway) to a network. For example, Router 116 may be implemented at the edge of a network to connect remote offices of an enterprise. In one embodiment, each enterprise office site has a Router 116 to connect to other sites of the enterprise, the enterprise intranet, and/or the Internet. In one embodiment, Router 116 includes an IP/VC (Internet Protocol/Video Conferencing) Gateway. In one embodiment, the IP/VC Gateway provides functionality to convert between various network protocols. Router 116 forwards and receives data packets from one local area network (LAN) or wide area network (WAN) to another. Based on routing tables and routing protocols, the Router 116 reads the network address in each transmitted frame and makes a decision on how to send it based on the most expedient route (traffic load, line costs, speed, bad lines, etc.). Router 116 may be used to segment LANs in order to balance traffic within workgroups and to filter traffic for security purposes and policy management.

In one embodiment, Router 116 includes a computer that is optimized for communications; however, the Router's 116 functions may also be implemented by adding routing software to a file server. For example, an operating system running on the Router 116 may include routing software that can route from one subnetwork to another if each one is connected to its own network adapter (NIC) in the server. It will be appreciated that in an embodiment where the call receiving computer 122 is connected to the same LAN 114 as the Gateway 110, Router 116 may be omitted, and voice packets are transmitted directly to Hub 118 from the LAN 114. In one embodiment, Hub 118 is integrated with Router 116.

Router 116 forwards data to Hub 118. Hub 118 connects together two or more network segments. In one embodiment, Hub 118 is a passive hub that simply forwards any data packets it receives over one port from a node to all remaining ports. In another embodiment, Hub 118 provides signal amplification to allow a network segment to be extended over a greater distance. Hub 118 may be used in a star topology, such as 10BaseT. In one embodiment, Hub 118 may be a multi-port twisted-pair hub which allows several point-to-point segments to be joined into one network. For example, one end of the point-to-point link is attached to the hub and the other is attached to a computer. In one embodiment, Hub 118 is attached to a network backbone, such that devices at the end of the twisted-pair segments may communicate with hosts on the backbone.

In one embodiment, Hub 118 conveys voice packets from Router 116 to a Wireless Access Point 120. Wireless Access Point 120 is a base station in a wireless LAN. In one embodiment, Access Point 120 is a stand-alone device that plugs into an Ethernet Hub 118 or server. Users of wireless access protocols can roam with their mobile devices which are handed off from one Access Point 120 to another. Access Points 120 cover a certain range, such as for example 1000 feet, and mobile users are automatically handed off from one to the other as they move in and out of the range of various Access Points 120. In one embodiment, the call receiving computer 122 is connected to the enterprise intranet through a wireless connection. The Access Point 120 then transmits the voice data packets to a call receiving computer 122 which includes a wireless access device for communication with the Access Point 120. In one embodiment, Access Point 120 is integrated with Hub 118.

In one embodiment, Hub 118 conveys voice data packets directly to a call receiving computer 122 over a physical connection such as twisted-pair cable. For example, in one embodiment, the call receiving computer 122 is connected to Hub 118 through an RJ-45 Ethernet cable.

In one embodiment, call receiving computer 122 is a computing device that is coupled to the LAN/WAN 114. Call receiving computer 122 may be a desktop computing device, a laptop computing device, or a portable computing device, such as a Personal Digital Assistant (PDA). The call receiving computer 122 may be connected to LAN/WAN 114 through various different means, such as a direct physical connection, a wireless connection, or through the Internet. Call receiving computer 122 receives the voice data packets from either the Hub 118 or a Wireless Access Point 120, and notifies a user of an incoming call. In one embodiment, a user is notified of the incoming call by a visual alert, such as an icon of a ringing telephone that appears on a display of the call receiving computer 122. In another embodiment, the user is notified by an audible alert, such as the sound of a ringing telephone. The user may receive the call through a speaker and microphone or other input/output device connected to the call receiving computer 122. For example, in one embodiment, the call receiving computer 122 has an integrated microphone and speaker. In another embodiment, the call receiving computer 122 is connected to a headset, which includes a speaker and a microphone. Such a headset may be connected to the call receiving computer 122 through a Universal Serial Bus (USB) port. Once connected, a user at the call receiving computer 122 may carry on a telephone conversation with a user at the call initiating telephone 102, in a similar manner as conventional telephone calls. In one embodiment, a graphical user interface (GUI) is provided on the call receiving computer 122 to provide the user with various call configuration options, such as volume, tone, caller identification (Caller ID), voicemail, and call waiting.

Once the call has been routed to the call receiving computer 122, the callee's portion of the conversation is transmitted to the call initiating telephone 102 through the routing system 100. In one embodiment, a callee's voice is received by the call receiving computer 122 through a microphone, and is converted by the call receiving computer 122 into packetized callee voice data for network transmission. The packetized callee voice data is transmitted through Hub 118 and Router 116 over LAN/WAN 114 to Gateway 110. Gateway 110 converts the packetized callee voice data into voice signals which are then transmitted through the PBX 104 to the call initiating telephone 102.

It will be appreciated that various devices in the above description of the call routing system 100 may be combined, omitted, or coupled in different configurations. For example, in one embodiment, PBX 104 and Call Router 106 may be combined into a single server computer. In one embodiment, the Call Router 106 may be combined with call receiving telephone 108. In one embodiment, Access Point 120 may be omitted. In another embodiment, Router 116 is combined with Hub 118 and Access Point 120 into a single device. In yet another embodiment, Call Router 106 is positioned between the call initiating telephone 102 and the PBX 104. In still yet another embodiment, the PBX may be omitted.

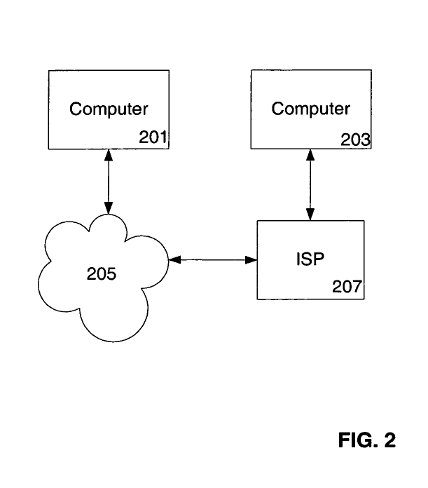

In one embodiment, as shown in FIG. 2, a computer 201 is part of, or coupled to a network 205, such as the Internet, to exchange data with another computer 203, as either a client or a server computer. For example, in one embodiment, the Gateway 110 of FIG. 1 is a computer 201 and is part of, or coupled to a network 205 to exchange data with other computers 203. Typically, a computer is coupled to the Internet through an ISP (Internet Service Provider) 207 and uses a conventional Internet browsing application to exchange data with a server. Other types of applications allow clients to exchange data through the network 205 without using a server. It will be readily apparent that the present invention is not limited to use with the Internet; directly coupled and private networks are also contemplated.

FIG. 3 illustrates an embodiment of a computer system that may be used with the present invention. For example, in one embodiment, call receiving computer 122 of FIG. 1 is a computing device or computer system similar to that described below with reference to FIG. 3. It will be apparent to those of ordinary skill in the art, however, that other alternative systems of various system architectures may also be used.

The data processing system illustrated in FIG. 3 includes a bus or other internal communication means 315 for communicating information, and a processor 310 coupled to the bus 315 for processing information. The system further comprises a random access memory (RAM) or other volatile storage device 350 (referred to as memory), coupled to bus 315 for storing information and instructions to be executed by processor 310. Main memory 350 also may be used for storing temporary variables or other intermediate information during execution of instructions by processor 310. The system also comprises a read only memory (ROM) and/or static storage device 320 coupled to bus 315 for storing static information and instructions for processor 310, and a data storage device 325 such as a magnetic disk or optical disk and its corresponding disk drive. Data storage device 325 is coupled to bus 315 for storing information and instructions.

The system may further be coupled to a display device 370, such as a cathode ray tube (CRT) or a liquid crystal display (LCD) coupled to bus 315 through bus 365 for displaying information to a computer user. An alphanumeric input device 375, including alphanumeric and other keys, may also be coupled to bus 315 through bus 365 for communicating information and command selections to processor 310. An additional user input device is cursor control device 380, such as a mouse, a trackball, stylus, or cursor direction keys coupled to bus 315 through bus 365 for communicating direction information and command selections to processor 310, and for controlling cursor movement on display device 370.

Another device, which may optionally be coupled to computer system 300, is a communication device 390 for accessing other nodes of a distributed system via a network. The communication device 390 may include any of a number of commercially available networking peripheral devices such as those used for coupling to an Ethernet, token ring, Internet, or wide area network. The communication device 390 may further be a null-modem connection, a wireless connection mechanism, or any other mechanism that provides connectivity between the computer system 300 and the outside world. For example, the communication device 390 may include coaxial cable, fiber-optic cable or twisted pair cable. Note that any or all of the components of this system illustrated in FIG. 3 and associated hardware may be used in various embodiments of the present invention.

It will be appreciated by those of ordinary skill in the art that any configuration of the system may be used for various purposes according to the particular implementation. The control logic or software implementing the present invention can be stored in main memory 350, data storage device 325, or any machine-accessible medium locally or remotely accessible to processor 310. A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.).

It will be apparent to those of ordinary skill in the art that the system, method, and process described herein can be implemented as software stored in main memory 350 or read only memory 320 and executed by processor 310. This control logic or software may also be resident on an article of manufacture comprising a computer readable medium having computer readable program code embodied therein and being readable by the data storage device 325 and for causing the processor 310 to operate in accordance with the methods and teachings herein.

The present invention may also be embodied in a handheld or portable device containing a subset of the computer hardware components described above. For example, the handheld device may be configured to contain only the bus 315, the processor 310, and memory 350 and/or 320. The present invention may also be embodied in a special purpose appliance including a subset of the computer hardware components described above. For example, the appliance may include a processor 310, a data storage device 325, a bus 315, and memory 350, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

The description of FIGS. 2 and 3 is intended to provide an overview of computer hardware and various operating environments suitable for implementing embodiments of the invention, but is not intended to limit the applicable environments. It will be appreciated that the system 300 is one example of many possible devices that have different architectures. A typical device will usually include at least a processor, memory, and a bus coupling the memory to the processor. Such a configuration encompasses personal computer systems, network computers, handheld devices, such as portable media devices, personal digital assistants, and similar devices. One of skill in the art will immediately appreciate that embodiments of the invention can be practiced with other system configurations, including multiprocessor systems, minicomputers, mainframe computers, and the like. Embodiments of the invention can also be practiced in distributed computing environments where tasks are performed by remote processing devices that are linked through a communications network.

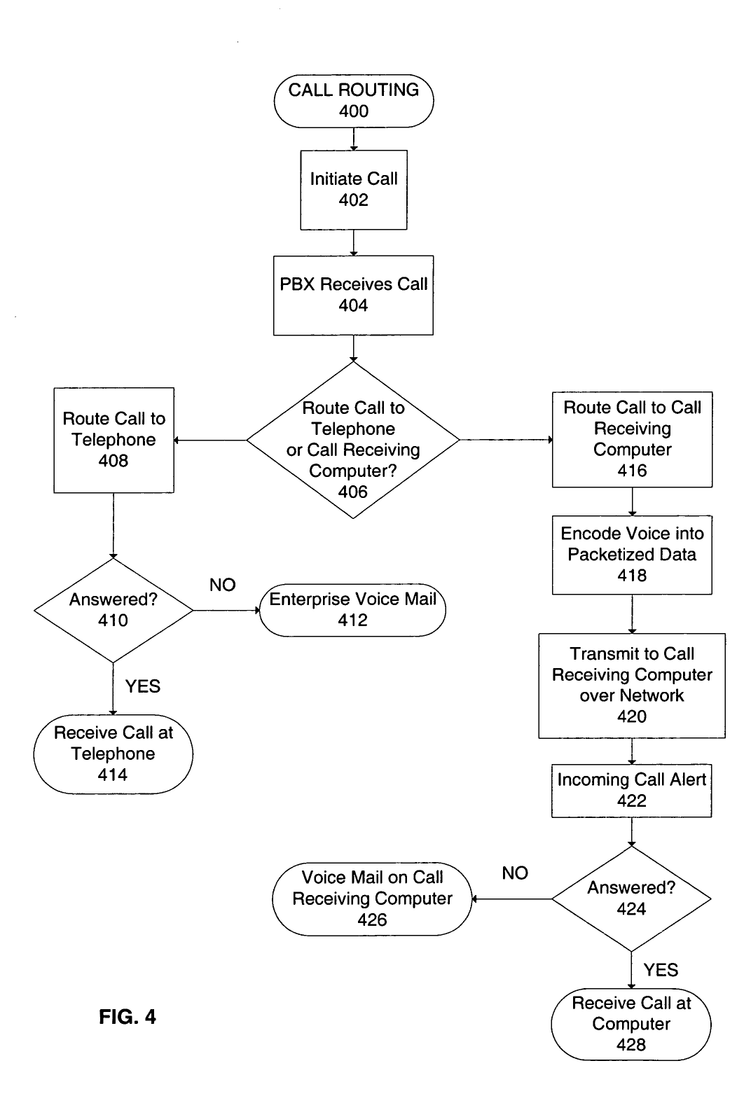

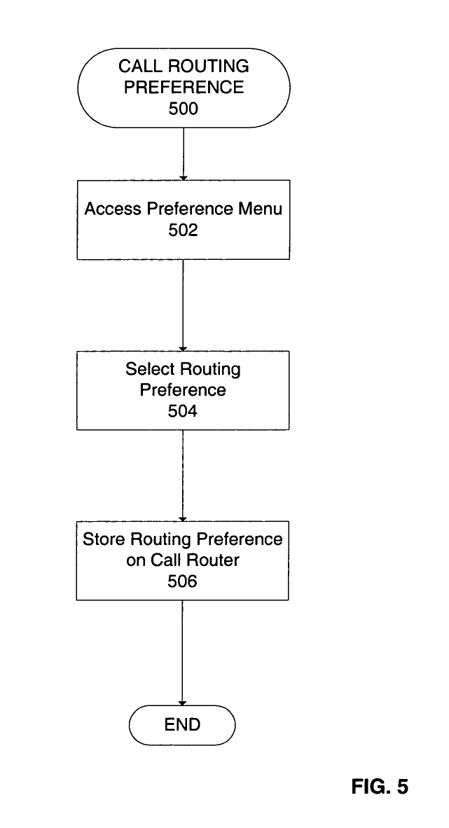

The particular methods of embodiments of the invention are described in terms of computer software with reference to a series of flow charts. FIG. 4 illustrates a flow chart of one embodiment of a call routing method 400. FIG. 5 illustrates an embodiment of a call routing preference method 500.

The methods 400 and 500 constitute computer programs made up of computer-executable instructions illustrated as blocks (acts) in FIGS. 4 and 5. Describing the methods by reference to a flow chart enables one skilled in the art to develop such programs including such instructions to carry out the methods on suitably configured computers. The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement embodiments of the invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be appreciated that embodiments including more or fewer processes may be incorporated into the methods illustrated in FIGS. 4 and 5 without departing from the scope of the invention and that no particular order is implied by the arrangement of blocks shown and described herein.

Referring to FIG. 4, an embodiment of a call routing method 400 is illustrated. A call is initiated at block 402. In one embodiment, the call originates from a telephone external to an enterprise, such as a telephone connected to the PSTN. In another embodiment, the call originates from a telephone within the enterprise. The call is received at the enterprise's PBX at block 404. The PBX routes the call to a call router associated with the called telephone extension. In one embodiment, a call router handles routing options for a plurality of telephone extensions within the enterprise.

At decision block 406, the call router makes a determination on how the call should be routed. In one embodiment, the call router makes the routing decision based on a user selectable telephone call routing preference setting. If the call routing preference is set to route calls to a call receiving telephone, the call is routed to the call receiving telephone at block 408. If the call routing preference is set to route calls to a call receiving computer, the call is routed to the call receiving computer at block 416.

In one embodiment, where the call is routed to the call receiving telephone, the call is passed to the call receiving telephone in a similar manner as conventional telephone calls. In other words, the call receiving telephone rings, indicating an incoming telephone call. If the call is answered at block 410, then the call is received by a callee at block 414. In one embodiment, if the call is not answered at block 410, then the call is transferred to a voice mail system for the caller to leave a message at block 412.

In one embodiment, where the call is routed to the call receiving computer, the voice signals of the call are encoded into packetized voice data at block 418, for transmission over a computer network at block 420. In one embodiment, the packetized voice data is routed to the call receiving computer by identifying the call receiving computer's network address based on a called party's username, which is associated with the called telephone extension. When the call is routed to the call receiving computer, an alert is displayed on the call receiving computer at block 422, indicating an incoming telephone call. In one embodiment, the alert may be an animated icon displayed on a display device of the call receiving computer.

If the telephone call is not answered at block 424, the call is transferred to a voice mail program on the call receiving computer at block 426. For example, the caller will receive an audible prompt that the callee is unavailable and that the caller should leave a voice message. In one embodiment, the voice mail program includes software running on the call receiving computer which is capable of storing a voice mail message from the caller in a digital audio format on the call receiving computer. In one embodiment, where a caller leaves a voice mail on the call receiving computer, an alert, such as an animated icon, is displayed on a display device of the call receiving computer to indicate to a user that a voice mail message is present. The user of the call receiving computer may then retrieve the stored voicemail from the call receiving computer at a convenient time.

In one embodiment, if the telephone call is answered by the callee at block 424, the call is received at the call receiving computer at block 428. Once a call is received by the callee at the call receiving computer, the callee may converse with the caller through the call receiving computer. For example, in one embodiment, a headset which includes a microphone and a speaker is coupled to the call receiving computer. The callee's voice is converted by the call receiving computer into packetized callee voice data, and transmitted over the network to the gateway. In one embodiment, the gateway converts the packetized callee voice data into a voice signal and transmits the voice signal to the call initiating telephone through the PBX.

Referring to FIG. 5, an embodiment of a call routing preference method 500 is illustrated. In one embodiment, a user may select a call routing preference using a software interface through which the call router is accessible. For example, in one embodiment, a call routing preference may be configured through a menu presented on a web page accessible through the enterprise's intranet or through the Internet. At block 502, a user accesses the preference menu by logging into a call routing preference web page. The web page presents the user with a menu of options for routing telephone calls. For example, in one embodiment, a user may choose between routing telephone calls to the user's office telephone or to a computer which the user is logged into. In one embodiment, the default setting for the call routing preference is to route calls to the user's office telephone. In another embodiment, the user may be presented with a menu of other call routing options, such as transferring calls directly to voice mail or forwarding calls to another telephone number. In one embodiment, the user is presented with a series of on-screen radio buttons that allow only one selection. If a button is currently selected, it will de-select when another button is selected. In another embodiment, the user may select more than one routing option.

In one embodiment, since calls may be routed to a call receiving computer based on a username, a user may receive calls on a computing device other than one which the user typically uses. For example, a user may visit a remote office of the enterprise, and log into the enterprise intranet using a computer which the user has not previously used. Since the username is used to route calls, the user may still receive calls at the computer, even though the user may have been unaware of the IP address or location of the computer that would be used to receive telephone calls at the time the user selected the call routing option.

At block 504, the user selects a routing preference on the web page. For example, the user may select a radio button to indicate that calls to the user's telephone extension should be routed to a call receiving computer instead of an office telephone. After selecting the routing preference, the user logs off of the web page. Once the routing preference has been selected, the routing preference is stored on the call router at block 506. In one embodiment, the routing preference is associated with the telephone extension on the call router. In one embodiment, the call router stores routing preferences for a plurality of telephone numbers or extensions within an enterprise.

In one embodiment, a user may select a call routing preference using a telephone menu interface through which the call router is accessible. For example, in one embodiment, a call routing preference may be configured by a user who dials a telephone number associated with the call router. The user accesses the call routing preference menu through the telephone by navigating through an audible menu. The audible menu presents the user with a menu of options for routing telephone calls. For example, in one embodiment, a user may choose between routing telephone calls to the user's office telephone or to a computer which the user logs into. In one embodiment, the user navigates the menu and indicates a call routing preference by pressing a button when prompted by the audible menu.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The above description of illustrated embodiments of the invention, including what is described in the Abstract, is not intended to be exhaustive or to limit the invention to the precise forms or embodiments disclosed. While specific embodiments of, and examples for, the invention are described herein for illustrative purposes, various equivalent modifications are possible within the scope of the invention, as those skilled in the relevant art will recognize. These modifications can be made to embodiments of the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method comprising:
receiving an incoming telephone call at a private branch exchange, the telephone call directed to a telephone extension of the private branch exchange;
determining a call routing preference associated with the extension; and
routing the telephone call based on the call routing preference, wherein routing the telephone call includes:
routing the telephone call to a telephone associated with the extension if the call routing preference is set to a first preference, and
routing the telephone call to a computing device associated with the extension if the call routing preference is set to a second preference.

2. The method of claim 1, further comprising storing the call routing preference at a call router.

3. The method of claim 2, wherein the call router stores a plurality of call routing preferences for a plurality of extensions of the private branch exchange.

4. The method of claim 2, further comprising setting a call routing preference through a web browser interface.

5. The method of claim 1, further comprising automatically setting the call routing preference to the second preference when the computing device associated with the extension is detached from a docking station.

6. The method of claim 1, wherein routing the telephone call to the computing device comprises:
encoding a voice signal of the telephone call into a digital format for transmission over a network;
determining a username associated with the extension;
determining a network address associated with the username, the network address assigned to the computing device; and
routing the telephone call to the network address.

7. The method of claim 6, wherein the computing device is connected to the network through a wireless connection.

8. The method of claim 6, wherein routing the telephone call to the computing device further comprises displaying an icon on a display of the computing device to indicate the incoming telephone call.

9. The method of claim 6, further comprising receiving the telephone call at the computing device.

10. The method of claim 6, wherein routing the telephone call to the computing device further comprises storing a voice mail message on the computing device if the incoming telephone call is not answered.

11. An article of manufacture comprising:
a machine-accessible medium including data that, when executed by a machine, cause the machine to perform operations comprising:
receiving an incoming telephone call at a private branch exchange, the telephone call directed to a telephone extension of the private branch exchange;
determining a call routing preference associated with the extension; and
routing the telephone call based on the call routing preference, wherein routing the telephone call includes:
routing the telephone call to a telephone associated with the extension if the call routing preference is set to a first preference, and
routing the telephone call to a computing device associated with the extension if the call routing preference is set to a second preference.

12. The article of manufacture of claim 11, wherein the machine-accessible medium further includes data that cause the machine to perform operations comprising storing the call routing preference at a call router.

13. The article of manufacture of claim 12, wherein the call router stores a plurality of call routing preferences for a plurality of extensions of the private branch exchange.

14. The article of manufacture of claim 12, wherein the machine-accessible medium further includes data that cause the machine to perform operations comprising setting a call routing preference through a web browser interface.

15. The article of manufacture of claim 11, wherein the machine-accessible medium further includes data that cause the machine to perform operations comprising automatically setting the call routing preference to the second preference when the computing device associated with the extension is detached from a docking station.

16. The article of manufacture of claim 11, wherein routing the telephone call to the computing device comprises:
encoding a voice signal of the telephone call into a digital format for transmission over a network;
determining a username associated with the extension;
determining a network address associated with the username, the network address assigned to the computing device; and
routing the telephone call to the network address.

17. The article of manufacture of claim 16, wherein the computing device is connected to the network through a wireless connection.

18. The article of manufacture of claim 16, wherein routing the telephone call to the computing device further comprises displaying an icon on a display of the computing device to indicate the incoming telephone call.

19. The article of manufacture of claim 16, wherein the machine-accessible medium further includes data that cause the machine to perform operations comprising receiving the telephone call at the computing device.

20. The article of manufacture of claim 16, wherein routing the telephone call to the computing device further comprises storing a voice mail message on the computing device if the incoming telephone call is not answered.

21. A system comprising:
a private branch exchange to receive an incoming telephone call directed to a telephone extension of the private branch exchange;
a computing device associated with the extension;
a call router to determine a call routing preference associated with the extension and to route the telephone call based on the call routing preference, wherein the call router routes the telephone call to a telephone associated with the extension if the call routing preference is set to a first preference, and wherein the call router routes the telephone call to the computing device associated with the extension if the call routing preference is set to a second preference; and
a twisted-pair cable connected to the computing device.

22. The system of claim 21, further comprising the call router to store the call routing preference.

23. The system of claim 22, wherein the call router stores a plurality of call routing preferences for a plurality of extensions of the private branch exchange.

24. The system of claim 22, further comprising a web browser interface to set a call routing preference.

25. The system of claim 21, further comprising the call router to automatically set the call routing preference to the second preference when the computing device associated with the extension is detached from a docking station.

26. The system of claim 21, further comprising:
a gateway to encode a voice signal of the telephone call into a digital format for transmission over a network; and
a gatekeeper to determine a username associated with the extension, to determine a network address associated with the username, the network address assigned to the computing device, and to route the telephone call to the network address.

27. The system of claim 21, wherein the computing device is selected from the group consisting of a desktop computer, a laptop computer and a personal digital assistant.

28. The system of claim 26, further comprising an icon displayed on a display of the computing device to indicate the incoming telephone call.

29. The system of claim 26, further comprising the computing device to receive the telephone call.

30. The system of claim 29, further comprising a headset coupled to the computing device.
